(19) United States
(12) Patent Application Publication
(10) Pub. No.: US 2016/0198301 A1
(43) Pub. Date: Jul. 7, 2016

(54) VALIDATING SERVICES BUSINESS ADDRESSES FROM PAYMENTS AND GEOLOCATION DATA

(71) Applicant: MasterCard International Incorporated, Purchase, NY (US)

(72) Inventor: Justin Xavier Howe, Oakdale, NY (US)

(21) Appl. No.: 14/591,116

(22) Filed: Jan. 7, 2015

(51) Int. Cl. H04W 4/02; G06Q 20/40; G06Q 20/32

(52) U.S. Cl. CPC H04W 4/023; G06Q 20/3224; G06Q 20/4014

(57) ABSTRACT

Systems, methods, and computer program products are provided for determining on a web map whether a business exists at a given location. A specialized computing device receives a possible geographic location indicating where the business may be. Details regarding device-present transactions completed with the business are accessed. Recognition IDs identifying locations for each associated geolocation device and associated payment instrument holder identifications of customers are received. Based upon the details regarding the completed device-present transactions, and the recognition IDs, a determination is made whether the business exists at the given location. Also presented is a system, method, and computer program product for utilization of details of completed payment instrument transactions completed with a mobile business using a mobile payment receiving device to display a location of a mobile business on a web map associated with a web mapping service.

### CROSS-REFERENCE TO RELATED APPLICATIONS

This application is related to U.S. non-provisional application Ser. No. 13/920,920, “Geo-Enumerative Deviceholder Authentication” (hereinafter “GEO-ENUMERATIVE DEVICEHOLDER AUTHENTICATION”), currently published as United States Patent Application Publication 2014/0372304, and application Ser. No. 13/671,791, “Methods for Geotemporal Fingerprinting.” (hereinafter “METHODS FOR GEOTEMPORAL FINGERPRINTING”), currently issued as U.S. Pat. No. 8,924,433. The full disclosure of these applications are incorporated in their entirety herein.

### FIELD OF THE DISCLOSURE

The present disclosure relates the field of payment instrument transactions and its application to web mapping services. More specifically, disclosed are systems, methods, and computer program products for determining whether or not businesses exist at a given location on a web map available through a web mapping service, utilizing details of completed transactions completed through the business. Also disclosed are a system, method, and computer program product for locating a mobile business accepting payments using a mobile payment receiving device on a web map associated with a web mapping service utilizing details of completed transactions. Such systems, methods, and computer program products provide the benefit of utilization of details of completed transactions as available to certain parties to a payment instrument transaction to improve quality of information available on the web mapping service.

### BACKGROUND OF THE DISCLOSURE

The internet and its continuously growing availability to billions of people worldwide is a disruptive technology that is fundamentally changing the nature of our society. Paper-based newspapers, maps, catalogs, telephone directories (such as the Yellowpages), and magazines are much less common, and simply being replaced by websites providing the same services. Individuals in the twenty-first century no longer even own paper-based copies of these, instead relying exclusively on the internet to provide such information. Of course, without the discipline imposed by actually paying a fee for inclusion in a paper-based publication like a newspaper or telephone directory, or by professional review for inclusion on a map, information available on the internet is doubtful in its quality and must be questioned.

With this background, enter web mapping services (such as Google® Maps or Mapquest®). Web mapping services offer the ability to search for any sort of business or other listing on a massive and visually beautiful crowd-sourced map. Since web mapping services are typically crowd-sourced projects, large amounts of data may be made available to users with little cost associated with them. Business owners may even use the crowd-sourced nature of these projects to list their businesses themselves. Unfortunately, the same crowd-sourced data by its very nature is subject to abuses, such as changing the hours a competitor business is open, writing unfavorable and false reviews of a competitor's business, overly positive and false reviews of one's own business, and even saying that one's own business is in a location it really is not located to attract customers (while not being able to immediately provide them with immediate service). As has been recognized, any of these points is capable of destroying a competitor business. Kevin Poulsen, How Google Map Hackers Can Destroy a Business at Will, WIRED (Jul. 7, 2014), available at http://www.wired.com/2014/07/hacking-google-maps (last visited Oct. 31, 2014).

Accordingly, in response, there is a need for a method, system, and computer program product for correctly, easily, and accurately determining business locations for the purposes of web mapping services and serving the public as a whole.

### SUMMARY OF THE DISCLOSURE

The present disclosure provides various methods, systems, and computer program products for utilization of details of completed transactions as well as recognition IDs identifying geolocations (or, simply, “locations”) of geolocation devices before, during, and when transactions are completed with mobile businesses or otherwise, to use such information to locate the mobile businesses or otherwise on a web map available via a web mapping service, such as Google® Maps. The “locations” in various embodiments may refer to locations of an actual location of a fixed business and/or to actual or service locations in the case of a mobile business (such as, for example, a locksmith that may accept payments at a fixed storefront as well as also accept payments at an individual's home location, where the locksmith is directly providing service).

In accordance with a first aspect of the present disclosure, a specialized computing device is utilized to determine on a web mapping service whether a business exists at a given location or not. During execution of the first aspect of the presently disclosed method, system, and computer program product, the specialized computing device receives a possible geographic location associated with a web map available on the web mapping service, the possible geographic location indicating where the business is said to exist on the web map. One or more computer databases associated with the specialized computing device are accessed, the one or more computer databases containing details regarding a plurality of completed device-present transactions completed with the business, including payment instrument holder identifications associated with business customers who entered or made each completed device-present transaction. The specialized computing device receives dynamically (i.e. continuously, as made available), a plurality of recognition IDs associated with a plurality of geolocation devices, the recognition IDs identifying locations for each geolocation device and payment instrument holder identifications of individuals associated with each geolocation device. The specialized computing device then determines whether a minimum number of individuals were at the possible geographic location when the transactions were completed, based upon the details regarding the plurality of completed device-present transactions, payment instrument holder identifications of individuals associated with each geolocation device, and the identified locations for each geolocation device identified by the recognition IDs and, if so, concluding that the business exists as the given location. The minimum number of individuals relied upon when concluding that the business exists at the given location may be one individual, two individuals, three individuals, five individuals, ten individuals, or fifteen individuals or more. An individual (or multiple individivals) may be determined to be at the possible geographic location if the individual is determined to be within a radius of the possible geographic location of the business when the device-present transaction associated with the individual was completed. The radius of the possible geographic location may be 50 feet, 100 feet, 200 feet, 500 feet, 1000 feet, and 1 block. Different individuals may rely upon different radii, such as available through different types of geolocation devices associated with the different individuals. In an embodiment of the present disclosure, each recognition ID may further indicate a time or times individuals associated with each geolocation device were at the identified location, and when the specialized computing device determines whether the minimum number of individuals were at the possible geographic location the determination is made, in-part, based upon the time the individuals were at the possible geographic location.

In accordance with a second aspect of the present disclosure, a specialized computing device is utilized to determine on a web mapping service whether a business may exist at a given location or not. During execution of the second aspect of the presently disclosed method, system, and computer program product, the specialized computing device receives a possible geographic location associated with a web map available on the web mapping service, the possible geographic location indicating where the business is said to exist on the web map. The specialized computing device then receives navigation data associated with the web map, and accesses one or more computer databases associated with the specialized computing device, the one or more computer databases containing details regarding a plurality of completed transactions completed with the business, the details including at least payment instrument holder identifications associated with business customers who made each completed transaction, and times each completed transaction was initiated. The specialized computing device receives dynamically a plurality of recognition IDs associated with a plurality of geolocation devices, the plurality of recognition IDs identifying one or more locations for each geolocation device, times each geolocation device was at each location, and payment instrument holder identifications of individuals associated with each geolocation device. In an embodiment, the specialized computing device may then filter recognition IDs which are not associated with the payment instrument holder identifications of business customers who made each completed transaction. The specialized computing device then determines whether the business may exist at the possible geographic associated with the web map location based upon the navigation data associated with the web map (including, by way of non-limiting example, distance information, speed limits, road information, intersection information, and traffic information), details regarding the plurality of completed transactions completed with the business including payment instrument holder identifications associated with business customers who made each completed transaction and times each completed transaction was initiated, and the dynamically received recognition IDs (filtered or unfiltered) identifying payment instrument holder identifications of individuals associated with each geolocation device, one or more locations for each geolocation device, and times each geolocation device was at each location.

In accordance with a third aspect of the present disclosure, details of a plurality of completed payment instrument transactions completed with a mobile business accepting payments using a mobile payment receiving device are used by a specialized computing device to display on a web map associated with a web mapping service a location of the mobile business. During execution of the third aspect of the presently disclosed system, method, and computer program product, the specialized computing device accesses a first computer database associated with the specialized computing device, the first computer database containing details regarding a plurality of completed transactions completed with the mobile business, payment instrument holder identifications associated with mobile business customers who made each completed transaction, and times each completed transaction was initiated. The specialized computing device accesses a second computer database associated with the specialized computing device, the second computer database providing each recognition ID associated with the payment instrument holder identifications of the mobile business customers who made each completed transaction, each recognition ID identifying one or more locations for each geolocation device, times each geolocation device was at each location, and payment instrument holder identifications of individuals associated with each geolocation device. A data structure is then generated, associating the payment instrument holder identifications associated with mobile business customers who completed transactions with recognition IDs accessed by the specialized computing device, the data structure identifying locations for geolocation devices associated with each accessed recognition ID, times each geolocation device was at each location, and payment instrument holder identifications of individuals associated with each geolocation device. The specialized computing device utilizes the data structure to determine the location of the mobile business. A location of the mobile business is then transmitted, the location to be displayed on the web map associated with the web mapping service. In an embodiment of the invention, when displaying on the web map associated with the web mapping service the location of the mobile business, a most recent estimated location for the location of the mobile business is displayed (in circumstances when other locations are available). In a further embodiment, prior to determining the location of the mobile business the specialized computing device requests from the user a time when the mobile business is at the location, followed by the specialized computing device transmitting the location of the mobile business at the time requested by the user.

Various aspects of these embodiments can be interwoven to provide for more efficient improvement of the quality of data available via web mapping services. In addition to the above aspects of the present disclosure, additional aspects, objects, features, and advantages will be apparent from the embodiments presented in the following description and in connection with the accompanying drawings.

### BRIEF DESCRIPTION OF THE DRAWINGS

Some embodiments are illustrated by way of example and not limitation in the figures of the accompanying drawings, in which like reference numerals refer to like structures across the several views, and wherein:

FIG. 1 illustrates a block diagram 100 displaying the process of completing a payment instrument transaction in an embodiment of the disclosure.

FIG. 2 illustrates a flow chart 200 displaying basic steps of a method comprising an embodiment of the disclosure.

FIG. 3 illustrates a block diagram 300 displaying structures and processes used in an embodiment of the disclosure.

FIG. 4 illustrates a flow chart 400 displaying basic steps of a method comprising an embodiment of the disclosure.

FIG. 5 illustrates a block diagram 500 displaying structures and processes used in an embodiment of the disclosure.

FIG. 6 illustrates a flow chart 600 displaying basic steps of a method comprising an embodiment of the disclosure.

FIG. 7 illustrates a block diagram 700 displaying structures and processes used in an embodiment of the disclosure.

### DETAILED DESCRIPTION OF THE EMBODIMENTS

The following sections describe exemplary embodiments of the present disclosure. It should be apparent to those skilled in the art that the described embodiments of the present disclosure are illustrative only and not limiting, having been presented by way of example only. All features disclosed in this description may be replaced by alternative features serving the same or similar purpose, unless expressly stated otherwise. Therefore, numerous other embodiments of the modification thereof are contemplated as falling within the scope of the present disclosure as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of, or consist of, the one or more recited components, and that there are methods according to the present disclosure that consist essentially of, or consist of, the one or more recited processing steps.

As will be appreciated by one skilled in the art, the present disclosure may be embodied as a system, method, or computer program product. Accordingly, the present disclosure may take the form of an entirely hardware embodiment, an entirely software embodiment (including firmware, resident software, micro-code, etc.) or an embodiment combining software and hardware aspects that may generally be referred to herein as a “server,” “device,” “computing device,” “general purpose computer,” “computer device,” or “system.” In an embodiment, a “specialized computing device” may be utilized providing functionality in connection with the presently disclosed system, method, and computer program apparatus. As is commonly known in the art, such devices are associated with a single or multiple processors or CPUs, which are specially programmed in order to perform a task at hand. Multiple computer systems may also be networked together via a motherboard, system bus, in a local-area network, or via the internet to perform the same function. Furthermore, the present disclosure may take the form of a computer program product embodied in any tangible medium of expression having computer usable program code embodied in the medium. Computer program code (or “computer program instructions”) for carrying out operations of the present disclosure may operate on any or all of a “server,” “device,” “computing device,” “general purpose computer,” “computer device,” “system,” or “specialized computing device” discussed herein. Computer program code for carrying out operations of the present disclosure may be written in any combination of one or more programming languages, including an object-oriented programming language such as Java, Smalltalk, C++, or the like and conventional procedural programming languages, such as Visual Basic, “C,” or similar programming languages. After-arising programming languages are contemplated as well.

The present disclosure is described below with reference to flowchart illustrations and/or block diagrams of methods, apparatuses (systems), and computer program products according to embodiments of the disclosure. It will be understood that each block of the flowchart illustrations and/or block diagrams, and combinations of blocks in the flowchart illustrations and/or block diagrams, may be implemented by computer program instructions.

Providing of such computer program instructions to the “server,” “device,” “computing device,” “general purpose computer,” “computer device,” “system,” or “specialized computing device” causes a machine to be produced, such that the computer program instructions when executed create means for implementing the functions/acts specified in the flowchart and/or block diagram block or blocks. These computer program instructions may also be stored in a computer-readable medium that may direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the “server,” “device,” “computing device,” “general purpose computer,” “computer device,” “system,” or “specialized computing device” or other programmable apparatus to produce a computer-implemented process such that the instructions which execute on the “server,” “device,” “computing device,” “general purpose computer,” “computer device,” “system,” or “specialized computing device” or other programmable apparatus to provide processes for implementing the functions/acts specified in the flowchart and/or block diagram block or blocks. The large amounts of data being processed by the presently disclosed systems, methods, and computer program products indicates a “server,” “device,” “computing device,” “general purpose computer,” “computer device,” “system,” and/or “specialized computing device” is a necessary element of the present disclosure.

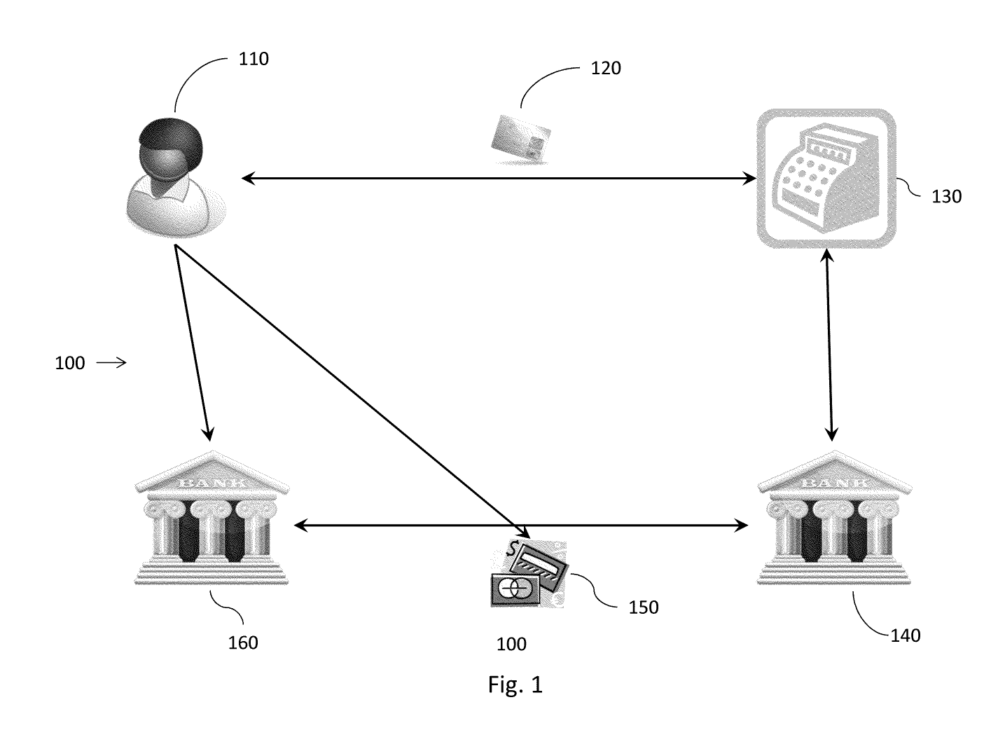

Referring to FIG. 1, there is shown a block diagram 100 displaying the general process of completing a payment transaction with a payment instrument in an embodiment of the disclosure. A customer (also known as a payment instrument holder) 110 desires to purchase a good or service from a merchant or other business 130. The merchant or other business 130 may be a mobile business or otherwise. The customer 110 is carrying a personal computing device (also known herein as a “geolocation device”) as he or she shops (not shown here). Personal computing devices that may be used as geolocation devices include cellular telephones, pagers, lap-tops, personal digital assistants, or other similar devices. Customer 110 presents a “payment instrument” 120 (such as a credit card, debit card, ATM card, CHIP card, electronic wallet, transponder device, NFC-enabled smart phone, PIN transaction, or similar current or after-arising technology) to the merchant or other business 130 for payment in connection with a payment transaction. The merchant or other business 130 utilizes his or her transaction acquiring device (also not shown) to communicate with a merchant acquiring institution or “Acquirer” 140 seeking approval for this transaction. In an embodiment of the disclosure, the transaction acquiring device may be a mobile payment receiving device, as used by a mobile business. The Acquirer 140 transmits an authorization message formatted pursuant to ISO 8583 (which is incorporated here in its entirety) or its present or after-arising equivalent. The authorization message contains “details” such as, at least, the customer's (110) payment instrument holder account identification (or “payment instrument holder identification”), other account information, amount of the transaction, time the transaction was initiated, etc., seeking approval for the transaction. The transmission is made via a payment instrument network 150 to a payment instrument issuing institution 160 associated with the payment instrument 120. Other “details” of a completed payment transaction are transmitted as well, including the preceding as well as (but not limited to) the geolocation where a payment transaction is occurring, the time the transaction was approved, and other related data. Should approval be appropriate, the payment instrument issuing institution 160 transmits an approval message via the payment instrument network 150 to the Acquirer 140 who then retransmits the approval message to the merchant 130, who thusly learns the sale has been completed. As previously discussed, the approval message is transmitted in formatting consistent with ISO 8583 or its present or after-arising equivalent.

In connection with the present disclosure, the customer 110 (or potential customer) broadcasts his or her geolocation using his or her personal computing device before, during, or after a payment transaction to the payment instrument issuing institution 160 and/or the payment instrument network 150 via a number of means as detailed below. Other customers, or potential customers (not shown here) also carrying personal computing devices broadcast their own geolocation at the same time. The broadcast of geolocation can take place in active or passive fashion. In one embodiment, the broadcasting of geolocation of personal computing devices is a passive process, not requiring an active choice to enroll in a program designed to track geolocations. The payment instrument issuing institution 160 and payment instrument network 150 are able to recognize the geolocation of a personal computing device via a “recognition ID,” which could include a phone number utilized by the personal computing device within a telephone network or over the internet, a Bluetooth identification, a Wi-Fi login, a device ID, a social media handle, a MAC address, or any other means of passively determining geolocation of a personal computing device without express consent of the holder of the personal computing device. These recognition IDs are obtained through observation of social media, SMS messages, a geolocation ping, logging into a public hot-spot, or other currently existing or after-arising technology. As a means of non-limiting example, the customer 110 transmits geolocation passively (without opt-in) via use of Bluetooth, Wi-Fi, MAC Address, phone cookie, cell tower ping, or activation of a link on a cell phone application. Alternately, in an embodiment of the disclosure one or more customers 110 opts-in to transmit geolocation via GPS on a mobile computing device via, for example, checking-in, offer redemption, sending an SMS requesting consent, answering a telephone call requesting consent, registration with a local node, etc., in order to allow more effective means of tracking of geolocation. In such an event, if consent is provided, a GPS location of the personal computing device may be provided statically or dynamically. These types of geolocation data may be updated continuously, at five minute intervals, at ten minute intervals, at hourly intervals, or according to any other period.

During operation, a computing system associated with a matching database operated by the payment instrument issuing institution 160 or the payment instrument network 150 receives a number of recognition IDs (from one to billions), with each execution indicating locations associated with recognition IDs of personal computing devices associated with one customer 110 or many potential customers. The purpose of the present disclosure is to utilize the passively (or actively) collected locations of personal computing devices in combination with information on completed payment transactions associated with payment instruments to allow linking of locations, merchant names, and payment instruments used to make purchases, providing various benefits to payment instrument holders, merchants, and the payment instrument institutions alike

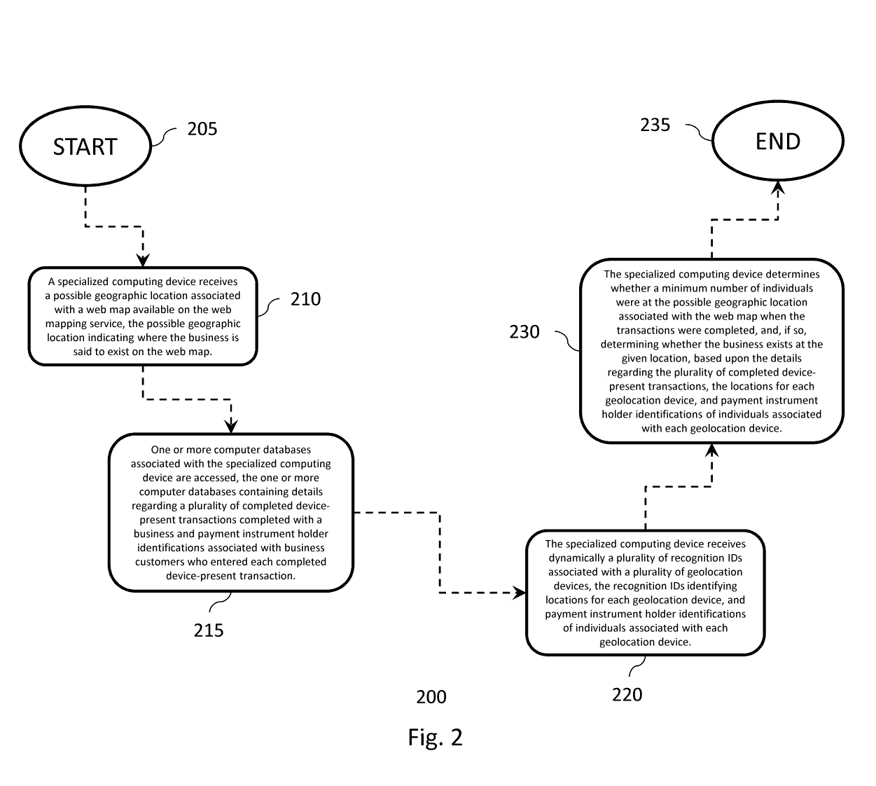

Referring to FIG. 2, shown is a flow chart 200 displaying basic steps of a method comprising an embodiment of the disclosure. The method disclosed in the flow chart 200 may also be utilized in connection with a system or computer program product, as discussed elsewhere herein. The steps may be performed in any order, and with or without certain steps. Execution begins at “START,” step 205. At step 210, in an embodiment of the disclosure, a specialized computing device receives a possible geographic location associated with a web map available on the web mapping service, the possible geographic location indicating where the business is said to exist on the web map. In other embodiments of the disclosure, a “server,” “device,” “computing device,” “general purpose computer,” “computer device,” or “system,” is used in place of or in conjunction with the “specialized computing device.” At step 215, one or more computer databases associated with the specialized computing device are accessed. The one or more computer databases contain details regarding a plurality of completed device-present transactions completed with a business and payment instrument holder identifications associated with business customers who entered or made each completed device-present transaction. At step 220, the specialized computing device dynamically receives a plurality of recognition IDs associated with a plurality of geolocation devices, the recognition IDs identifying locations for each geolocation device, and payment instrument holder identifications of individuals associated with each geolocation device. The recognition IDs may have been previously associated with geolocation devices, such as via a method, system, and/or computer product as disclosed in connection with GEO-ENUMERATIVE DEVICEHOLDER AUTHENTICATION. In an embodiment of the disclosure, at step 220 a time the individuals associated with each geolocation device were at the identified location is provided as well. In further embodiments, other locations the associated individuals were at as well as a time or times the associated individuals were at these locations is also provided. At step 230 the specialized computing device determines whether a minimum number of individuals were at the possible geographic location associated with the web map when the transactions were completed, and if so, whether the business exists at the given location, based on the details regarding the plurality of completed device-present payment transactions, the locations for each geolocation device, and payment instrument holder identifications of individuals associated with each geolocation device. In various embodiments of the disclosure, the number of individuals relied upon when concluding that the business exists at the given location may comprise one individual, two individuals, three individuals, five individuals, ten individuals, and fifteen individuals. Greater numbers of individuals may be relied upon as well, depending upon on the consistency of the data provided. One individual of the minimum number of individuals may be determined to be at the possible geographic location if the at least one individual is determined to be within a radius of the possible geographic location of the business when the device-present transaction(s) associated with the individual are completed. The radius may be 50 feet, 100 feet, 200 feet, 500 feet, 1000 feet, and 1 block. Greater radii may be considered as well, up to one-half or one mile, depending upon on the resolution of data provided by the recognition IDs. Note different recognition IDs associated with different individuals may also provide different levels of resolution and thus require different radii to determine if the individual is at a location (such as, for example, a cellular telephone with an enabled GPS function which provides a very accurate location versus a cellular telephone logging into a large wireless network, which provides a very large location). In an embodiment of the disclosure, the results of such an inquiry are returned to the requester after step 230. In further embodiments, the specialized computing device, utilizes the time the individuals associated with each geolocation device and/or other locations the associated individuals were at as well as times the associated individuals were at these locations, if provided, in determining whether a minimum number of individuals were at the possible geographic location. At step 235, execution terminates.

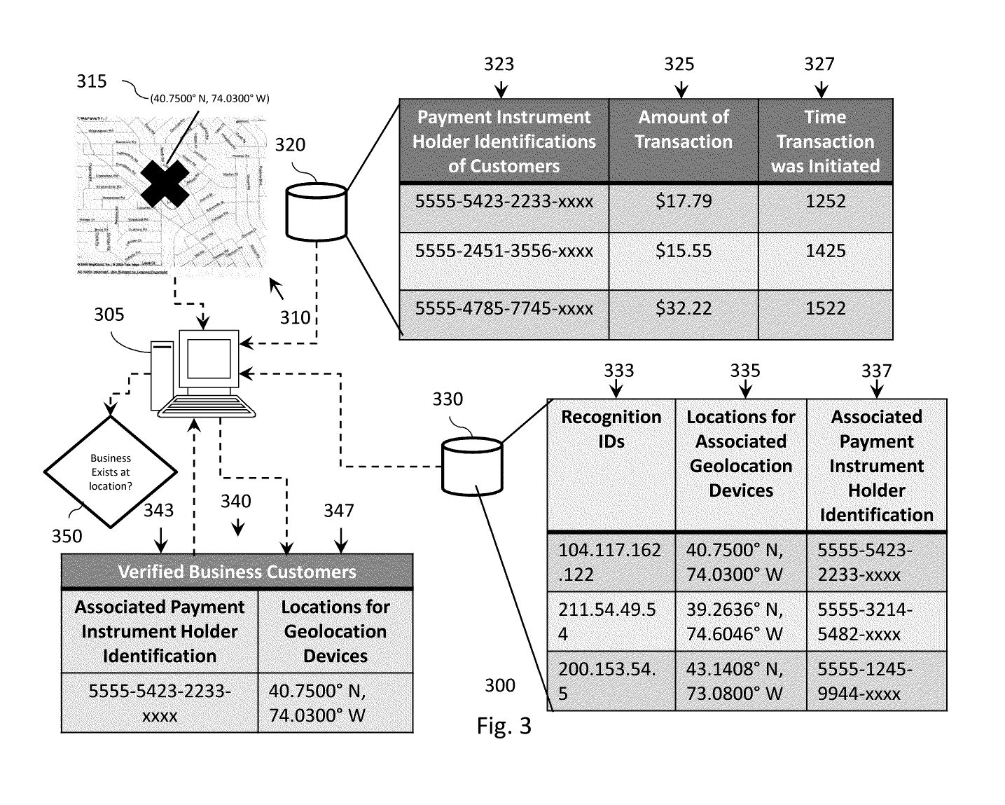

Referring to FIG. 3, shown is a block diagram 300 displaying structures used in an embodiment of the disclosure. A specialized computing device 305 (or other type of computing device, as discussed previously) receives via the internet or otherwise a possible geographic location 315 where a business may exist. The geographic location 315 may be associated with a web map 310. The web map is one such as available via an internet or other network connection, such as Google® Maps, Mapquest®, Wikimapia, or any other. The computing device 305 has access to a database 320 (or other computer-implemented means) associated with the computing device 305 which maintains details regarding a plurality of completed device-present transactions completed with the business including the associated payment instrument holder identifications 323 of customers who completed each completed device-present transaction. Also maintained among the details regarding the plurality of completed device-present transactions are the amount of the transaction 325, as well as the time the transaction was initiated 327. In other embodiments, other details are used in place of the time the transaction was initiated 327, such as the time the transaction was approved, or the time the transaction was transmitted, as in other embodiments these details may be more important in the determination of whether the business exists at the given location. The database 320 in various embodiments may be maintained by an acquirer 140, a payment instrument network 150, a payment instrument issuing bank 160, or any other party that has agreed to or is responsible for maintaining such data. A second database 330 (or any other computer-implemented means) maintains a plurality of recognition IDs. The second database 330 may maintain one or more recognition IDs 333, geographic locations for the geolocation devices 335 associated with the recognition IDs, as well as payment instrument holder identification 337 associated with each recognition ID. Other embodiments may store other datapoints, such as a time the geolocation device was at each location, other locations the geolocation device was found, etc. The computing device generates a data structure 340 or other computer-implemented means, containing all payment instrument holder identifications of customers 343 that have a geolocation device location 347 associated with them. In various embodiments herein, a “data structure” may refer to any computer-implemented storage data structure or its equivalent, including a matrix, array, linked-list, tree-structure, or other presently-existing or after-arising equivalent, providing computer-based storage on a computing device. Physical means are contemplated as well, including memory, hard-drives, tape-drives, etc. Such information 343 and 347 is used after generation by the specialized computing device 305 to determine whether the business exists at the given location 350. In effect, the computing device 305 determines whether customers associated with payment instrument holder identifications were at the possible geographic location making payments, and making payments at the business in question. Such determination 350 may be returned to a requestor, or made available as desired to a user or computer program.

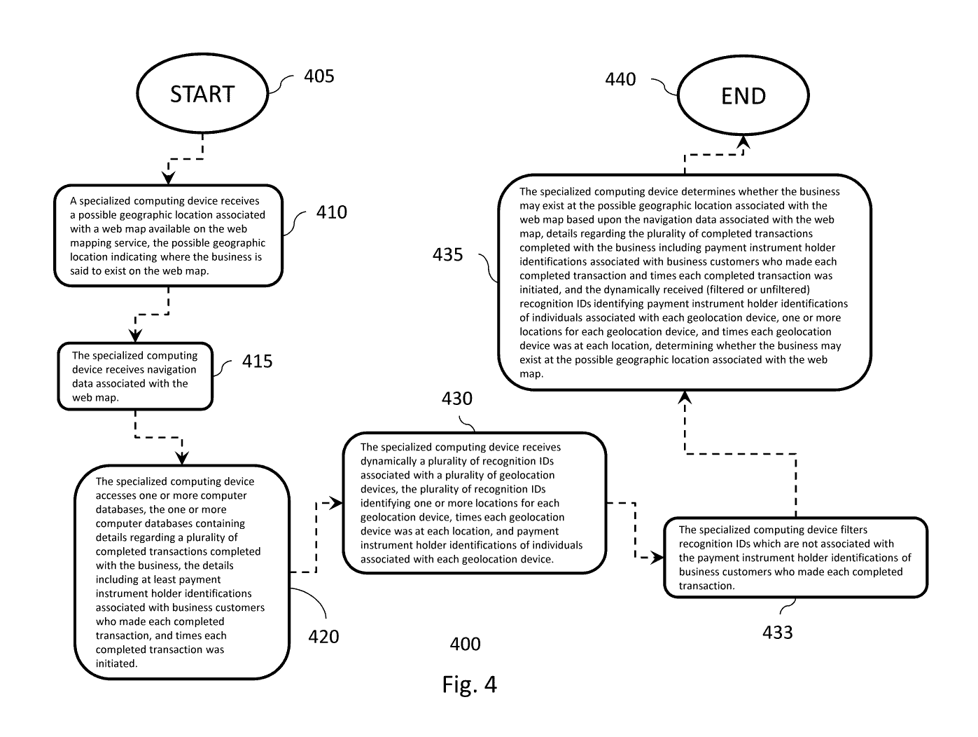

Referring to FIG. 4, shown is a flow chart 400 displaying basic steps of a method comprising an embodiment of the disclosure. The method disclosed in the flow chart 400 may also be utilized in connection with a system or computer program product, as discussed elsewhere herein. The steps may be performed in any order, and with or without certain steps. Execution begins at “START,” step 405. At step 410, a specialized computing device receives a possible geographic location associated with a web map available on the web mapping service, the possible geographic location indicating where the business is said to exist on the web map. In other embodiments of the disclosure, as previously, a “server,” “device,” “computing device,” “general purpose computer,” “computer device,” or “system,” is used in place of or in conjunction with the “specialized computing device.” At step 415 the specialized computing device receives navigation data associated with the web map. In an embodiment of the disclosure, receiving navigation data associated with the web map includes receiving by the specialized computing device distance information, speed limits, and possibly road information, intersection information, and traffic information intersections, etc., such as provided by a web map. Navigation data such as speed limits includes such limits for each relevant road, as well as areas for each speed limit on each road in the geographic region. Distance information includes distances of each road in a geographic region, as well as distances between intersections, etc. Such basic distance information is utilized with other graph search algorithms (such as but not limited to Dijkstra's shortest path, Edmond's, etc.) and is used to determine a shortest route or other reasonable route for navigation between two points. Other data may be made available via the web map including road information (such as closures, construction and associated modified speed limits, etc.), intersection information (noting locations of traffic lights, stop signs, yield signs, etc., and calculating for estimated times of slowing down, stopping (if required), accelerating, etc.), as well as traffic information (as adjusting the speed limit for a period of time, etc.).

At step 420, the specialized computing device accesses one or more associated computer databases (via an internet connection, network connection, system bus, or by any other means, as is appropriate), the one or more computer databases containing details regarding a plurality of completed transactions completed with the business. The details include at least payment instrument holder identifications associated with business customers who made each completed transaction, and times each completed transaction was initiated. At step 430, the specialized computing device receives dynamically a plurality of recognition IDs associated with a plurality of geolocation devices. The plurality of recognition IDs identify one or more locations for each geolocation device, times each geolocation device was at each location, and payment instrument holder identifications of individuals associated with each geolocation device. Optionally, at step 433 the computing device may filter recognition IDs which are not associated with the payment instrument holder identifications of customers who completed each transaction previously. This step is performed to limit the amount of data being processed at any given time and minimize drain on system resources. Alternately, in other embodiments recognition IDs may be filtered based upon geographic region (such as a radius from the possible geographic location of step 410). At step 435, the specialized computing device determines whether the business may exist at the possible geographic location associated with the web map based upon the navigation data associated with the web map, details regarding the plurality of completed transactions completed with the business (including payment instrument holder identifications associated with business customers who completed each transaction and times each completed transaction was initiated), and the dynamically-received recognition IDs of each geolocation device associated with the payment instrument holder identifications of individuals associated with each geolocation device, one or more locations for each geolocation device, and times each geolocation device was at each location, concluding that the business may exist at the possible geographic location associated with the web map. At step 440, execution terminates.

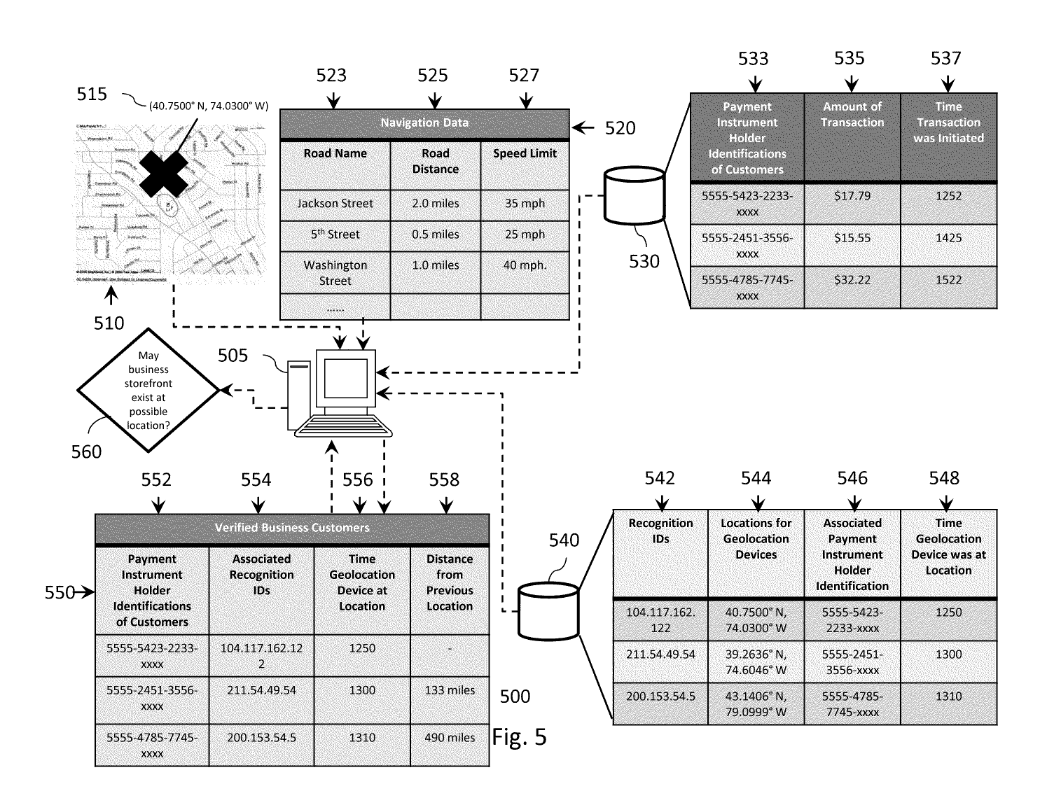

Referring to FIG. 5, shown is a block diagram 500 displaying structures used in an embodiment of the disclosure. A specialized computing device 505 (or other type of computing device, as discussed previously) receives via the internet or otherwise a possible geographic location 515 where a business may exist. The geographic location 515 may be associated with a web map 510. The web map is one such as available via an internet or other network connection, such as web mapping services such as Google® Maps, Mapquest®, Wikimapia, or any other. The computing device 505 also receives navigation data associated with the web map 520 (as such navigation data is discussed in connection with FIG. 4 and discussed previously herein). The navigation data includes data such as the road name 523, the road distance 525 (i.e. length of the road, as calculated by the web map depending on entrance and egress, etc.), and the speed limit 527 of the relevant segment of road. The specialized computing device 505 has access to a database 530 (or other computer-implemented means) which maintains details regarding a plurality of completed device-present transactions completed with the business, including the payment instrument identifications of customers 533, amounts of the transactions 535, and times transactions were initiated 537. In other embodiments, other details are used in place of the time the transaction was initiated 537, such as the time the transaction was approved, or the time the transaction was transmitted, as in other embodiments these details may be more important in the determination of whether the business exists at the given location. The database 530 in various embodiments may be maintained by an acquirer 140, a payment instrument network 150, a payment instrument issuing bank 160, or any other party that maintains such data. A second database 540 (or any other computer-implemented means) maintains a plurality of recognition IDs associated with a plurality of geolocation devices. The second database 540 may maintain one or more recognition IDs 542, geographic locations for the geolocation devices 544 associated with the recognition IDs, payment instrument holder identification 546 associated with each recognition ID, and times the geolocation device was at each location 548. In other embodiments, the second database 540 may store other datapoints, such as other locations for each geolocation device, as well as times when the geolocation devices were at those locations. Such data is useful for more complex determinations, as discussed below. In an embodiment, the second database 540 is accessed by the specialized computing device 505 specifically to obtain the recognition ID data 542-548 specifically associated with the payment instrument holder identifications previously obtained from 530. In some embodiments, the access is “dynamic,” and as customers continue to shop or move in other ways the associated geolocation devices continue to receive further recognition ID data 542-548.

The specialized computing device 505 then generates a data structure 550 or other computer-implemented means (as further discussed herein), containing payment instrument holder identifications of customers 552 (obtained from 533) and the associated recognition IDs 554 (obtained from 542) and times the geolocation device was at each location 556 (obtained from 548). 552, 554, and 556 are used in combination with the navigation data 520 to calculate distances from each previous location 558, (if there is a previous calculation to calculate the distance from). In an embodiment, such distance 558 is used in connection with speed limits 527 previously transmitted to determine whether an individual could drive between locations in the time allotted. Since the distances shown 558 are hundreds of miles apart, it is apparent a mobile business could not have traveled the distances shown 558 in the relevant times 556, and therefore it is determined that a mobile business may not exist 560 at geographic location 515.

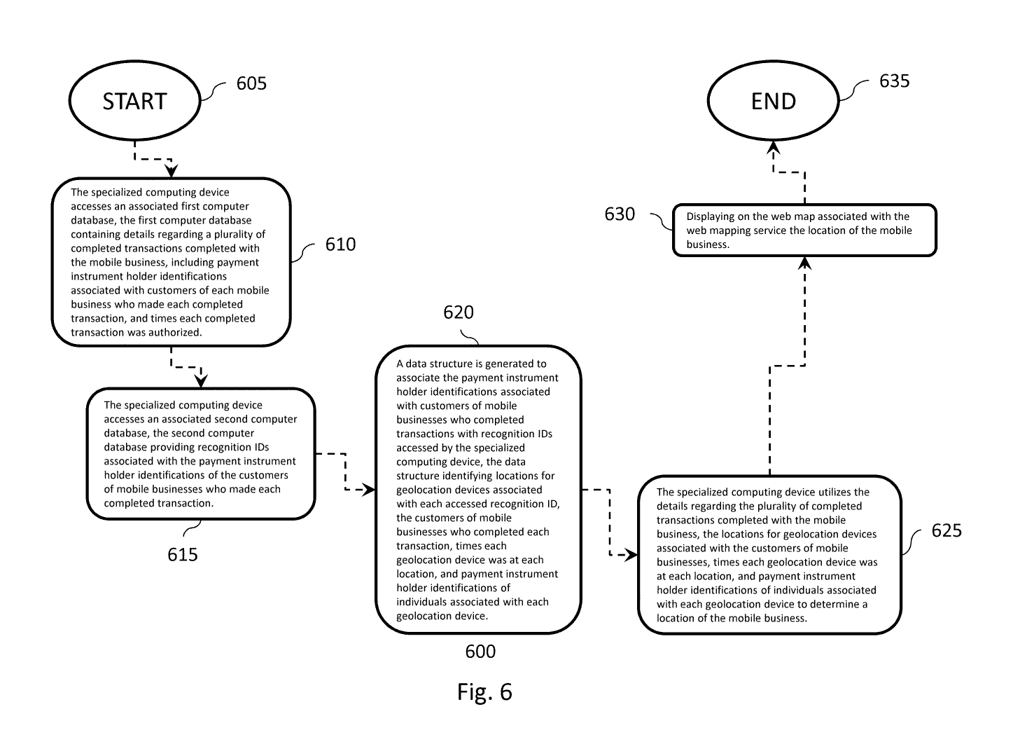

Referring to FIG. 6, shown is a flow chart 600 displaying basic steps of a method comprising an embodiment of the disclosure. The method disclosed in the flow chart 600 may also be utilized in connection with a system or computer program product, as discussed elsewhere herein. The steps may be performed in any order, and with or without certain steps. Execution begins at “START,” step 605. At step 610, the specialized computing device accesses a first computer database associated with the specialized computing device, the first computer database containing details regarding a plurality of completed transactions completed with the mobile business, payment instrument holder identifications associated with customers of the mobile business who made each completed transaction, and times each completed transaction was initiated. At step 615 the specialized computing device accesses a second computer database, the second computer database providing (dynamically or not) each recognition ID associated with the payment instrument holder identifications of the customers of the mobile business who made each completed transaction. In other embodiments of the disclosure, as previously, a “server,” “device,” “computing device,” “general purpose computer,” “computer device,” or “system,” is used in place of or in conjunction with the “specialized computing device.” At step 620, a data structure is generated to associate the payment instrument holder identifications associated with customers of mobile businesses who completed transactions with the recognition IDs accessed by the specialized computing device, the data structure identifying locations for geolocation devices associated with each accessed recognition ID, the customers of the mobile business who completed each transaction, times each geolocation device was at each location, and payment instrument holder identifications of individuals associated with each geolocation device. At step 625, the specialized computing device utilizes the details regarding the plurality of completed transactions completed with the mobile business, the locations for geolocation devices associated with the mobile business customers, times each geolocation device was at each location, and payment instrument holder identifications of individuals associated with each geolocation device to determine a location of the mobile business. At step 630, the location of the mobile business is displayed on the web map. In an embodiment of the disclosure, the mobile business is displayed on the web map at the most recent estimated location. In another embodiment, prior to determining the location of the mobile business, a time for determining the location of the mobile business is requested from the user, i.e. where the mobile business is at what time, and when displaying the location of the mobile business, the location of the mobile business at the time requested by the user is displayed. At step 635 execution terminates.

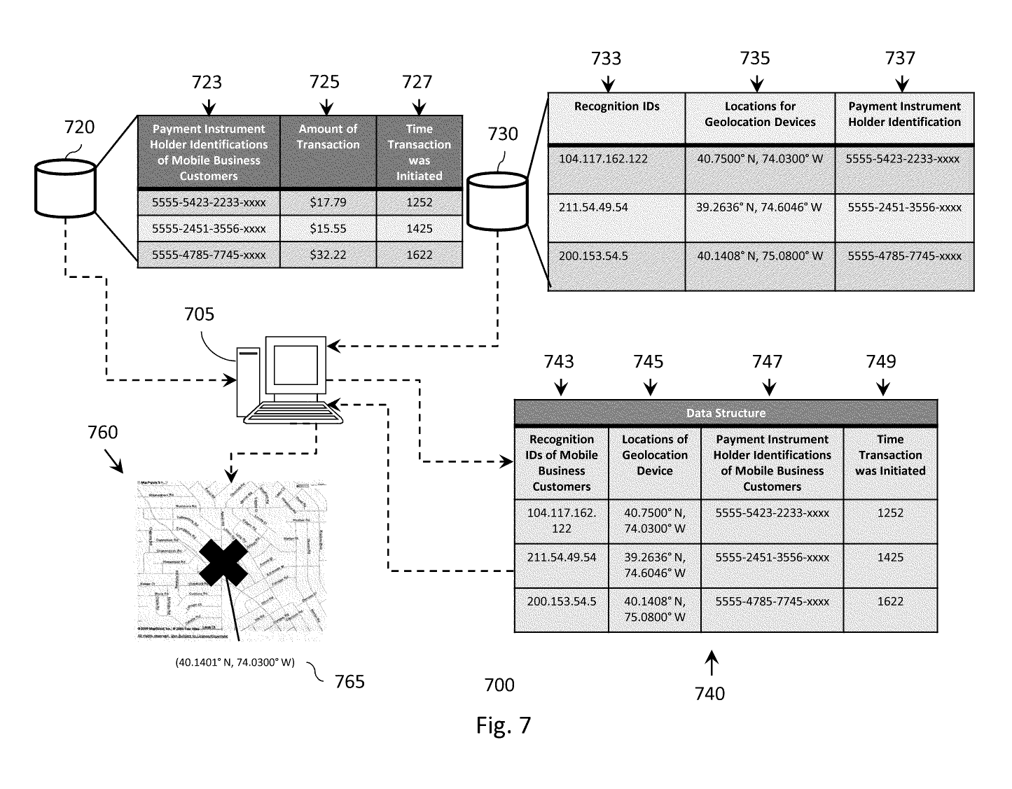

Referring to FIG. 7, shown is a block diagram 700 displaying structures used in an embodiment of the disclosure. A specialized computing device 705 (or other type of computing device, as discussed previously) accesses a first computer database 720 associated with the specialized computing device. The first computer database contains details regarding a plurality of completed transactions completed with the mobile business, including payment instrument holder identifications associated with mobile business customers 723 who completed each transaction, amounts of each transaction 725, and times each completed transaction was initiated 727. The computing device 705 also accesses a second computer database 730, the second computer database 730 including each recognition ID 733 associated with each payment instrument holder identification 737 identified as completing a transaction in the first database 720, as well as the associated location for the associated geolocation devices 735. The computing device 705 generates a data structure 740 (as further discussed herein) associating payment instrument holder identifications of mobile business customers 747 with the recognition IDs of the same mobile business customers 743, if such exist, and such were accessed by the computing device 705 previously. The data structure 740 also provides locations of geolocation devices 745, as well as times transactions were initiated 749. This data structure 740 is utilized by the specialized computing device 705 to determine a location of the mobile business 765 on the web map 760 based upon the location of the most recent transaction or location of mobile businesses at the time requested by the user.

As would be appreciated by one of skill in the art, the present disclosure will comply with all relevant state, federal, and international laws regarding data privacy and otherwise.

What is claimed is:

1. A method of utilizing a specialized computing device to determine on a web mapping service whether a business exists at a given location or not, said method comprising:
Receiving by the specialized computing device a possible geographic location associated with a web map available on the web mapping service, the possible geographic location indicating where the business is said to exist on the web map;
Accessing one or more computer databases associated with the specialized computing device, the one or more computer databases containing details regarding a plurality of completed device-present transactions completed with the business including payment instrument holder identifications associated with business customers who entered each completed device-present transaction;
Receiving dynamically by the specialized computing device a plurality of recognition IDs associated with a plurality of geolocation devices, the recognition IDs identifying locations for each geolocation device, and payment instrument holder identifications of individuals associated with each geolocation device; and
Determining by the specialized computing device whether a minimum number of individuals were at the possible geographic location associated with the web map when transactions were completed based upon the details regarding the plurality of completed device-present transactions, payment instrument holder identifications of individuals associated with each geolocation device, and the identified locations for each geolocation device identified by the recognition IDs, and, if so, concluding that the business exists at the given location.

2. The method of claim 1, wherein the minimum number of individuals relied upon when concluding that the business exists at the given location comprises selectively one of the following: one individual, two individuals, three individuals, five individuals, ten individuals, and fifteen individuals.

3. The method of claim 1, wherein at least one individual of the minimum number of individuals is determined to be at the possible geographic location if the at least one individual is determined to be within a radius of the possible geographic location of the business when the device-present transactions associated with the at least one individual was completed.

4. The method of claim 3, wherein the radius is selectively one of the following: 50 feet, 100 feet, 200 feet, 500 feet, 1000 feet, and 1 block.

5. The method of claim 1, wherein each recognition ID further indicates a time or times the individuals associated with each geolocation device were at the identified location, and when the specialized computing device determines whether the minimum number of individuals were at the possible geographic location the specialized computing device determines this, in-part, based upon the time or times the individuals were at the possible geographic location.

6. A method of utilizing a specialized computing device to determine on a web mapping service whether a business may exist at a given location or not, said method comprising:
Receiving by the specialized computing device a possible geographic location associated with a web map available on the web mapping service, the possible geographic location indicating where the business is said to exist on the web map;
Receiving by the specialized computing device navigation data associated with the web map;
Accessing one or more computer databases associated with the specialized computing device, the one or more computer databases containing details regarding a plurality of completed transactions completed with the business, the details including at least payment instrument holder identifications associated with business customers who made each completed transaction, and times each completed transaction was initiated;
Receiving dynamically by the specialized computing device a plurality of recognition IDs associated with a plurality of geolocation devices, the plurality of recognition IDs identifying one or more locations for each geolocation device, times each geolocation device was at each location, and payment instrument holder identifications of individuals associated with each geolocation device; and
Determining by the specialized computing device whether the business may exist at the possible geographic location associated with the web map, based upon the navigation data associated with the web map, details regarding the plurality of completed transactions completed with the business including payment instrument holder identifications associated with business customers who made each completed transaction and times each completed transaction was initiated, and the dynamically received recognition IDs identifying payment instrument holder identifications of individuals associated with each geolocation device, one or more locations for each geolocation device, and times each geolocation device was at each location.

7. The method of claim 6, wherein receiving navigation data associated with the web map includes receiving by the specialized computing device distance information, speed limits, and selectively zero or more of the following: road information, intersection information, and traffic information.

8. The method of claim 6, wherein the specialized computing device filters recognition IDs which are not associated with the payment instrument holder identifications of business customers who made each completed transaction before determining whether the business may exist at the possible geographic location associated with the web map.

9. A method of using, by a specialized computing device, details of a plurality of completed payment instrument transactions completed with a mobile business accepting payments using a mobile payment receiving device to display on a web map associated with a web mapping service a location of the mobile business, said method comprising:
Accessing a first computer database associated with the specialized computing device, the first computer database containing details regarding a plurality of completed transactions completed with the mobile business, payment instrument holder identifications associated with mobile business customers who made each completed transaction, and times each completed transaction was initiated;
Accessing by the specialized computing device a second computer database associated with the specialized computing device, the second computer database providing each recognition ID associated with the payment instrument holder identifications of the mobile business customers who made each completed transaction, each recognition ID identifying one or more locations for each geolocation device, times each geolocation device was at each location, and payment instrument holder identifications of individuals associated with each geolocation device;
Generating a data structure to associate the payment instrument holder identifications associated with mobile business customers who completed transactions with recognition IDs accessed by the specialized computing device, the data structure identifying locations for geolocation devices associated with each accessed recognition ID, times each geolocation device was at each location, and payment instrument holder identifications of individuals associated with each geolocation device;
Utilizing the data structure by the specialized computing device to determine the location of the mobile business; and
Transmitting the location of the mobile business to be displayed on the web map associated with the web mapping service.

10. The method of claim 9, wherein when displaying on the web map associated with the web mapping service the location of the mobile business, displaying a most recent estimated location for the location of the mobile business.

11. The method of claim 9, further comprising prior to determining the location of the mobile business requesting from the user a time when the mobile business is at the location.

12. The method of claim 11, further comprising transmitting the location of the mobile business at the time requested by the user.

13. A system using a specialized computing device for determining on a web mapping service whether a business exists at a given location or not, said system comprising:
The specialized computing device receiving a possible geographic location associated with a web map available on the web mapping service, the possible geographic location indicating where the business is said to exist on the web map;
The specialized computing device accessing one or more associated computer databases, the one or more computer databases containing details regarding a plurality of completed device-present transactions completed with the business including payment instrument holder identifications associated with business customers who entered each completed device-present transaction;
The specialized computing device receiving dynamically a plurality of recognition IDs associated with a plurality of geolocation devices, the recognition IDs identifying locations for each geolocation device, and payment instrument holder identifications of individuals associated with each geolocation device; and
The specialized computing device determining whether a minimum number of individuals were at the possible geographic location associated with the web map when transactions were completed based upon the details regarding the plurality of completed device-present transactions, payment instrument holder identifications of individuals associated with each geolocation device, and the identified locations for each geolocation device identified by the recognition IDs, and, if so, concluding that the business exists at the given location.

14. The system of claim 13, wherein the minimum number of individuals relied upon when concluding that the business exists at the given location comprises selectively one of the following: one individual, two individuals, three individuals, five individuals, ten individuals, and fifteen individuals.

15. The system of claim 13, wherein at least one individual of the minimum number of individuals is determined to be at the possible geographic location if the at least one individual is determined to be within a radius of the possible geographic location of the business when the device-present transactions associated with the at least one individual was completed.

16. The system of claim 15, wherein the radius is selectively one of the following: 50 feet, 100 feet, 200 feet, 500 feet, 1000 feet, and 1 block.

17. The system of claim 13, wherein each recognition ID further indicates a time or times the individuals associated with each geolocation device were at the identified location and when the specialized computing device determines whether the minimum number of individuals were at the possible geographic location the specialized computing device determines this, in-part, based upon the time or times the individuals were at the possible geographic location.

18. A system utilizing a specialized computing device to determine on a web mapping service whether a business may exist at a given location or not, said system comprising:
The specialized computing device receiving a possible geographic location associated with a web map available on the web mapping service, the possible geographic location indicating where the business is said to exist on the web map;
The specialized computing device receiving navigation data associated with the web map;
The specialized computing device accessing one or more computer databases, the one or more computer databases containing details regarding a plurality of completed transactions completed with the business, the details including at least payment instrument holder identifications associated with business customers who made each completed transaction, and times each completed transaction was initiated;
The specialized computing device receiving dynamically a plurality of recognition IDs associated with a plurality of geolocation devices, the plurality of recognition IDs identifying one or more locations for each geolocation device, times each geolocation device was at each location, and payment instrument holder identifications of individuals associated with each geolocation device; and
The specialized computing device determining whether the business may exist at the possible geographic location associated with the web map, based upon the navigation data associated with the web map, details regarding the plurality of completed transactions completed with the business including payment instrument holder identifications associated with business customers who made each completed transaction and times each completed transaction was initiated, and the dynamically received recognition IDs identifying payment instrument holder identifications of individuals associated with each geolocation device, one or more locations for each geolocation device, and times each geolocation device was at each location.

19. The system of claim 18, wherein when the specialized computing device receives navigation data associated with the web map, the navigation data includes distance information, speed limits, and selectively zero or more of the following: road information, intersection information, and traffic information.

20. The system of claim 18, further comprising the specialized computing device filtering recognition IDs which are not associated with the payment instrument holder identifications of business customers who made each completed transaction before determining whether the business may exist at the possible geographic location associated with the web map.

21. A system using by a specialized computing device details of a plurality of completed payment instrument transactions completed with a mobile business accepting payments using a mobile payment receiving device to display on a web map associated with a web mapping service a location of the mobile business, said system comprising:
The specialized computing device accessing a first computer database, the first computer database containing details regarding a plurality of completed transactions completed with the mobile business, payment instrument holder identifications associated with mobile business customers who made each completed transaction, and times each completed transaction was initiated;
The specialized computing device accessing a second computer database, the second computer database providing each recognition ID associated with the payment instrument holder identifications of the mobile business customers who made each completed transaction, each recognition ID identifying one or more locations for each geolocation device, times each geolocation device was at each location, and payment instrument holder identifications of individuals associated with each geolocation device;
The specialized computing device generating a data structure to associate the payment instrument holder identifications associated with mobile business customers who completed transactions with recognition IDs accessed by the specialized computing device, the data structure identifying locations for geolocation devices associated with each accessed recognition ID, times each geolocation device was at each location, and payment instrument holder identifications of individuals associated with each geolocation device;
The specialized computing device utilizing the data structure to determine a location of the mobile business; and
The specialized computing device transmitting the location of the mobile business to be displayed on the web map associated with the web mapping service.

22. The system of claim 21, wherein when the specialized computing device displays on the web map associated with the web mapping service the location of the mobile business, the specialized computing device displays a most recent estimated location for the location of the mobile business.

23. The system of claim 21, further comprising prior to the specialized computing device determining the location of the mobile business, requesting from the user a time when the mobile business is at the location.

24. The system of claim 23, wherein the specialized computing device transmits the location of the mobile business at the time requested by the user.

25. A system using a web mapping service, a specialized computing device, one or more associated databases, and a plurality of geolocation devices for determining on a web mapping service whether a business exists at a given location or not, said system comprising:
A web mapping service associated with a web map transmitting a possible geographic location to a specialized computing device, the possible geographic location indicating where a business is said to exist on the web map;
One or more associated computer databases accessed by the specialized computing device containing details regarding a plurality of completed device-present transactions completed with the business including payment instrument holder identifications associated with business customers who made each completed device-present transaction;
A plurality of geolocation devices associated with a plurality of recognition IDs received dynamically by the specialized computing device, the recognition IDs identifying locations for each geolocation device and payment instrument holder identifications of individuals associated with each geolocation device; and
The specialized computing device determining whether a minimum number of individuals were at the possible geographic location associated with the web map when transactions were completed based upon the details regarding the plurality of completed device-present transactions, payment instrument holder identifications of individuals associated with each geolocation device, and the identified locations for each geolocation device identified by the recognition IDs, and, if so, concluding that the business exists at the given location.

26. The system of claim 25, wherein the minimum number of individuals relied upon when concluding that the business exists at the given location comprises selectively one of the following: one individual, two individuals, three individuals, five individuals, ten individuals, and fifteen individuals.

27. The system of claim 25, wherein at least one individual of the minimum number of individuals is determined to be at the possible geographic location if the at least one individual is determined to be within a radius of the possible geographic location of the business when the device-present transaction associated with the at least one individual was completed.

28. The system of claim 25, wherein the radius is selectively one of the following: 50 feet, 100 feet, 200 feet, 500 feet, 1000 feet, and 1 block.

29. The system of claim 25, wherein each recognition ID further indicates a time or times the individuals associated with each geolocation device were at the identified location and the specialized computing device determines whether the minimum number of individuals were at the possible geographic location based in-part upon the time or times the individuals were at the possible geographic location.

30. A system using a web mapping service, a specialized computing device, one or more associated computer databases, and a plurality of geolocation devices to determine on the web mapping service whether a business may exist at a given location or not, said system comprising:
A web mapping service associated with a web map transmitting a possible geographic location to a specialized computing device, the possible geographic location indicating where the business is said to exist on the web map;
The specialized computing device receiving navigation data associated with the web map;
One or more associated computer databases accessed by the specialized computing device containing details regarding a plurality of completed transactions completed with the business, the details including at least payment instrument holder identifications associated with business customers who made each completed transaction, and times each completed transaction was initiated;
A plurality of geolocation devices associated with a plurality of recognition IDs received dynamically by the specialized computing device, the plurality of recognition IDs identifying one or more locations for each geolocation device, times each geolocation device was at each location, and payment instrument holder identifications of individuals associated with each geolocation device; and
The specialized computing device determining whether the business may exist at the possible geographic location associated with the web map, based upon the navigation data associated with the web map, details regarding the plurality of completed transactions completed with the business including payment instrument holder identifications associated with business customers who made each completed transaction and times each completed transaction was initiated, and the dynamically received recognition IDs identifying payment instrument holder identifications of individuals associated with each geolocation device, one or more locations for each geolocation device, and times each geolocation device was at each location.

31. The system of claim 30, wherein when the specialized computing device receives navigation data associated with the web map, the navigation data includes distance information, speed limits, and selectively zero or more of the following: road information, intersection information, and traffic information.

32. The system of claim 30, further comprising the specialized computing device filtering recognition IDs which are not associated with the payment instrument holder identifications of business customers who made each completed transaction before determining whether the business may exist at the possible geographic location associated with the web map.

33. A system for displaying on a web map associated with a web mapping service a location of a mobile business, said system comprising:
A first computer database accessed by a specialized computing device, the first computer database containing details regarding a plurality of completed transactions completed with a mobile business, payment instrument holder identifications associated with mobile business customers of a mobile business who made each completed transaction, and times each completed transaction was initiated;
A second computer database accessed by the specialized computing device, the second computer database providing each recognition ID associated with the payment instrument holder identifications of the mobile business customers who made each completed transaction, each recognition ID identifying one or more locations for each geolocation device, times each geolocation device was at each location, and payment instrument holder identifications of individuals associated with each geolocation device;
A specialized computing device for generating a data structure to associate the payment instrument holder identifications associated with mobile business customers who completed transactions with recognition IDs accessed by the specialized computing device, the data structure identifying locations for geolocation devices associated with each accessed recognition ID, times each geolocation device was at each location, and payment instrument holder identifications of individuals associated with each geolocation device, said specialized computing device utilizing the data structure to determine a location of the mobile business and transmitting the location of the mobile business to a web mapping service; and
A web mapping service for displaying on a web map the location of the mobile business.

34. The system of claim 33, wherein when the specialized computing device displays on the web map associated with the web mapping service the location of the mobile business, the specialized computing device displays a most recent estimated location for the location of the mobile business.

35. The system of claim 33, further comprising prior to the specialized computing device determining the location of the mobile business, the specialized computing device requesting from the user a time when the mobile business is at the location.

36. The system of claim 35, wherein the specialized computing device transmits the location of the mobile business at the time requested by the user.
